(19) United States
(12) Patent Application Publication
(10) Pub. No.: US 2018/0293392 A1
(43) Pub. Date: Oct. 11, 2018

(54) METHOD AND SYSTEM FOR SELECTING A COMMUNICATION INTERFACE

(71) Applicant: ISWIND DIGITAL ENGINEERING INC., TAIPEI CITY (TW)

(72) Inventor: RAPHAEL TSAI, TAIPEI CITY (TW)

(21) Appl. No.: 15/479,930

(22) Filed: Apr. 5, 2017

(51) Int. Cl. G06F 21/62; H04L 29/06; H04L 9/32

(52) U.S. Cl. CPC G06F 21/6209; H04L 9/3263; H04L 63/104; H04L 63/101

(57) ABSTRACT

The disclosure is related to a system and a method for managing group files. The system allows a user to begin a work project and set up an access control list that is used to control the project. The user-side device can first acquire a certificate corresponding to an access control list. Then the access control list is configured to set up one or more policy groups that manage the access privilege of a file. Each policy group has one or more members. When the policy groups are in operation, the member in each policy group acquires the certificate of the group's access control list from the management host, and can synchronously acquire a privilege data given by the certificate. According to the privilege data, the member in the policy group is allowed to read, write, print, copy, delete, and convert the file generated under the access control list.

### BACKGROUND OF THE INVENTION

### 1. Field of the Invention

The disclosure is generally related to a file management technology, in particular to a system and a method using an Access Control List to manage group files.

### 2. Description of Related Art

Cloud technology has been invented in response to the need for faster information sharing, management, and storage in our everyday life. However, providers also inevitably face the issues in cloud information security that has not yet been solved in an efficient way. Thus, a variety of solutions for managing shared files in the cloud has been introduced.

A conventional solution for storing a file to the cloud is based on a client-server framework. The server manages the files uploaded from end users and protects the files with encryption. This solution allows end users to share the encrypted files according to their individual access privilege.

U.S. Patent Publication No. 20090106549, filed on Jul. 30^{th}, 2008, discloses a file-encrypting extension system to address the information security issue. In the system, user identity information plays a huge role in file sharing. An encryption certificate is generated between a client agent and a trusted service account. The header of each encrypted file includes signed encrypted data blocks, file system metadata, and a digital signature. Therefore, when a user attempts to open an encrypted file, the client agent transmits the header data and the encryption certificate of the user to the trusted service account. The encryption certificate is required to be added to the file system metadata in order for the user to be authorized to access the file.

Nevertheless, when the conventional technology conducts authorization through security certificate or digital signature, it is generally related to file management under a server-client framework that lacks hierarchical management and flexibility in usage of the file.

### SUMMARY OF THE INVENTION

The disclosure in accordance with the present disclosure is related to a management system for group files. The system manages file access based on an Access Control List (abbreviated to ACL) while a user privilege control and a policy group mechanism are utilized. A subscriber is given permission to customize an ACL, which is configured to have various policy groups that help the subscriber to manage one or more file access privileges of his work project. Each policy group includes one or more members who can be subordinate to multiple different policy groups. When a policy group is in operation, its members' access rights to the group files can be altered according to the group privilege policy. The policy controls the members' permission and prohibition to read, write, print, copy, delete, and convert the encrypted files.

More specifically, in one embodiment of the management system, the system has one or more processors and a memory, and also reveals various modules that complete the process of file management. The server-side starts with the ACL management module creating a work project that connects ACL and policy groups. Then the encryption certificate management module generates a unique ACL certificate for subscribers to download according to their privileges. There is also the policy group management module which controls members' access rights under the policy group's particular privilege, and the file privilege management module which controls the access rights of one specific encrypted file. While these modules complete their processes on the server-side management system, the client-side has the subscribers to download and install the management driver. When an encrypted file is accessed, the management driver will acquire the ACL data, the encryption certificate, the group privilege data, and the file privilege data from the server.

Besides the members' general access rights, the policy group management module also controls the time privilege, which makes the configuration of access rights in different time periods become possible. Furthermore, an inheritance management mechanism is also introduced, which is utilized based on a tree structure. The inheritance control can be applied to any policy groups within a group tree. Members in these policy groups can obtain hierarchical access rights according to the inheritance controls even if they belong to different ACLs. In addition to the above explanations, an encrypted file header always includes ACL ID lists, the creator's token, the time privilege, the number of access, a security-related file encryption key, a file rescue key, and a file user key.

The file management method in one of the embodiments includes:

first selecting or creating an ACL for a work project, or obtaining a predetermined ACL;

acquiring a certificate corresponding to the ACL from the server-side management system;

creating one or more policy groups subordinate to the ACL, in which each policy group includes one or more members;

each member acquires a certificate corresponding to the ACL from the server-side management system, and each member synchronously obtains a group privilege with respect to one or more policy groups he belongs according to the certificate. Every member may be subordinate to one or more policy groups at the same time, and can obtain different access privileges with respect to one or more policy groups. When a policy group is in operation, according to the group privilege policy, every group member has access to the files subordinate to the ACL. A member can perform actions such as read, write, print, copy, delete, and convert files according to the group privilege policy.

More specifically, after installing the management driver on the client-side device, a subscriber will acquire related certificates delivered by the server-side management system through a messaging method. When a member creates a file under an ACL, the client-side management driver is executed to restrict the file usage to the authorized members only based on the group privilege policy and tracks their activities in the related policy groups.

Further, the steps for every member to access a file created under a policy group which is subordinate to an ACL are:

opening a file after the client-side management driver is executed;

the client-side management driver verifies the member's identity and certificate related to his access privilege;

if a member's device does not have any certificate, the client-side management driver will request related certificates and group privilege policy from the server-side management system. If the member's belonging group privilege policy and ACL policy gives him permission, the member will have privilege to open the file;

if a member's device has related certificates and the group privilege policy gives him permission, then the member's access privilege is confirmed, which allows the member to open the file.

In addition, the policy group management module not only manages the members' access privileges in each policy group but also time privileges. A file header in the policy group records information such as ACL ID lists, the creator's token, the time privilege, the number of access, a security-related file encryption key, a file rescue key, and a file user key, which are all registered under the client-side management system. The member's access right to a file created under a policy group associated to an ACL is determined by the member's privilege data, and the privilege includes the rights to read, write, print, copy, delete, and convert the encrypted files.

### BRIEF DESCRIPTION OF THE DRAWINGS

FIG. 1 shows a schematic diagram describing a framework related to the server-side management system in accordance with the present disclosure;

FIG. 2 shows another schematic diagram describing a fundamental framework of the client-side management in one embodiment in accordance with the present disclosure;

FIG. 3 shows a flow chart depicting a management method of group files according to one embodiment of the present disclosure;

FIG. 4 shows a flow chart depicting a situation when the client-side management driver responses to a request according to one further embodiment of the present disclosure;

FIG. 5 shows a flow chart depicting another situation when the client-side management driver responses to a request with inheritance data according to one embodiment of the present disclosure;

FIG. 6A shows a schematic diagram describing a group file management method for a learning center with different subjects according to one embodiment of the present disclosure;

FIG. 6B shows a table depicting time privileges of the management system for students in a learning center in one embodiment of the present disclosure;

FIG. 7 shows a schematic diagram describing students' privilege status in the same subject group of a learning center in one embodiment of the present disclosure;

FIG. 8 shows a schematic diagram describing a hierarchical relationship in a company applying the management method of group files in one embodiment of the present disclosure;

FIG. 9 schematically shows a method of sharing files between different groups and ACLs in the management system according to one embodiment of the present disclosure;

FIG. 10 shows a schematic diagram depicting a method of groups' time privilege controls in a project life cycle applying the management method for group files in one embodiment of the present disclosure.

### DETAILED DESCRIPTION OF THE PREFERRED EMBODIMENTS

The present disclosure will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The disclosure in accordance with the present disclosure is related to a management method for group files. The method is such as a solution to manage a user privilege that is referred to creating a policy group associated to an access control list (abbreviated to ACL). The ACL renders a certificate. A member of a policy group, which is subordinate to the ACL, can obtain the corresponding certificate, thereby owning a privilege for accessing a specific file. The system assigns the privilege for the member to access the file based on the member's policy group. The privilege restricts the member to read, write, print, copy, delete, and convert the file. Therefore, any changes, e.g. adding or removing, in members or policy groups will not modify the header of the file under an ACL.

To implement the management system and the method in accordance with the present disclosure, a file management core is provided and can be implemented by the server, or act as a core of a computer system. This file management core is provided to allocate a certificate to every ACL, and manage the privilege for each policy group and every member.

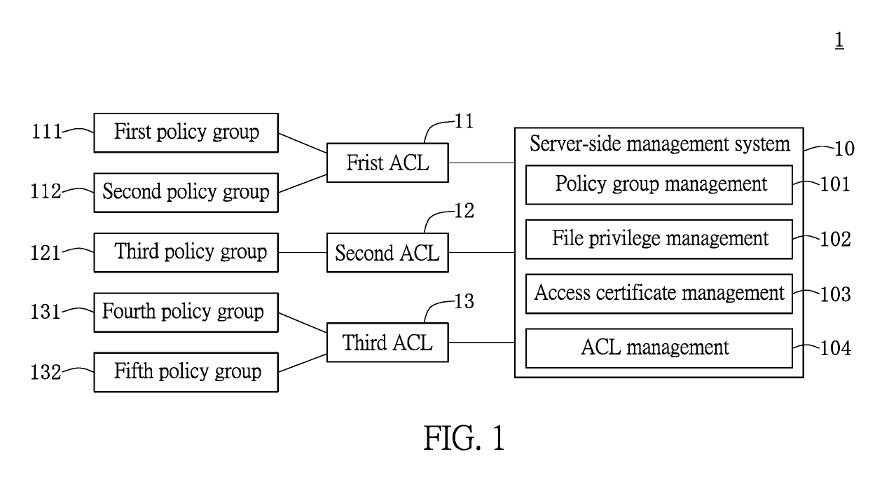

Reference is made to FIG. 1, in which a schematic diagram is used to depict a framework related to the server-side management system in accordance with the present disclosure. The server-side management system 1 includes a data management host 10, which can be a remote server, a local computer system, or a service installed onto a computer. Besides rendering a service in a computer, the data management host 10 also operates a management service for the files produced under an ACL while it connects with the member's computer over the Internet or a local area network. The data management host 10 can render services such as a policy group management 101, a file privilege management 102, an access certificate management 103, or an ACL management 104. The services allow the members to access files created under an ACL and are implemented in the software as four modules: the policy group management module, the file privilege management module, the access certificate management module, and the ACL management module.

The software-implemented policy group management module 101 is used to manage the policy groups, and is configured to set a group privilege data, e.g. a group profile, for each policy group. The group privilege data records user privilege(s) in each policy group and controls its members access rights. The file privilege management module 102 is used to manage the privilege set to every file. When a user wishes to access a file, not only does he need to comply with the privilege restrictions of the related policy group, but the privilege specified in the file privilege data also stipulates how the user can access the file. The access certificate management module 103 is provided for the system to manage the certificate for every ACL. When an ACL for a work project has been created, or a default ACL has been selected, the system allows the user to download a certificate for identifying the user ID. This certificate is written into the header of the file(s) within the policy group associated to the ACL. The ACL management module 104 is used to manage the ACL created by the management system.

Under the management mechanism of the group file(s) of the disclosure, the management system allows users to customize or preset an ACL for a work project. The ACL is registered in the server-side management system. The operation to the related project files will be in compliance with the group privilege configured in the ACL. The header of the accessible file records ACL ID lists, the creator's token, the time privilege, and the number of access. The policy group defines the member's privilege through the policy group privilege data. Therefore, the system identifies a user and his privilege to determine whether or not he is permitted to access a file: The policy group manages and controls the way a user access a file. Under this management mechanism, when a user or a member produces a file under an ACL, the access privilege of this file is applicable to all other policy groups subordinate to the same ACL. It is worth noting that the mentioned management mechanism is different from the general file management system of the conventional technology. For example, when a file is produced within a company division, e.g. a policy group, the file is only accessible to this company division due to privilege restrictions even if there are other divisions under the same company and the same server.

Further, one or more ACLs can be selected or created according to various requirements of different work projects. The ACLs are shown as a first ACL 11, a second ACL 12 and a third ACL 13. An ACL of a specific work project can associate to one or more policy groups. Each policy group accepts one or more members. The members within the same policy group can subordinate to different ACLs. The members may acquire different privileges within different ACLs.

In the embodiment shown in the diagram, a first ACL 11 manages a first policy group 111 and a second policy group 112 that respectively have one or more members. The members may be subordinate to different policy groups at the same time. The members access the file based on their privileges set by their policy groups associated to the ACL. A second ACL 12 associates with a third policy group 121. A third ACL 13 associates with a fourth policy group 131 and a fifth policy group 132.

From the client-side, a software, or a management driver, is introduced to perform the management service on a user computer. According to one embodiment, a user who is subordinate to a specific policy group first downloads the management driver from a data management host 10. The management driver is a software program executed in the user device. It allows the user to customize a work project and create a file for this project in the user device. The driver also assists the user in obtaining a certificate related to the ACL and acquiring the privilege to access the files within the policy group. The user device can synchronize the group privilege data and the file privilege data with the data management host 10. The user then can acquire associated information between the policy group and the ACL.

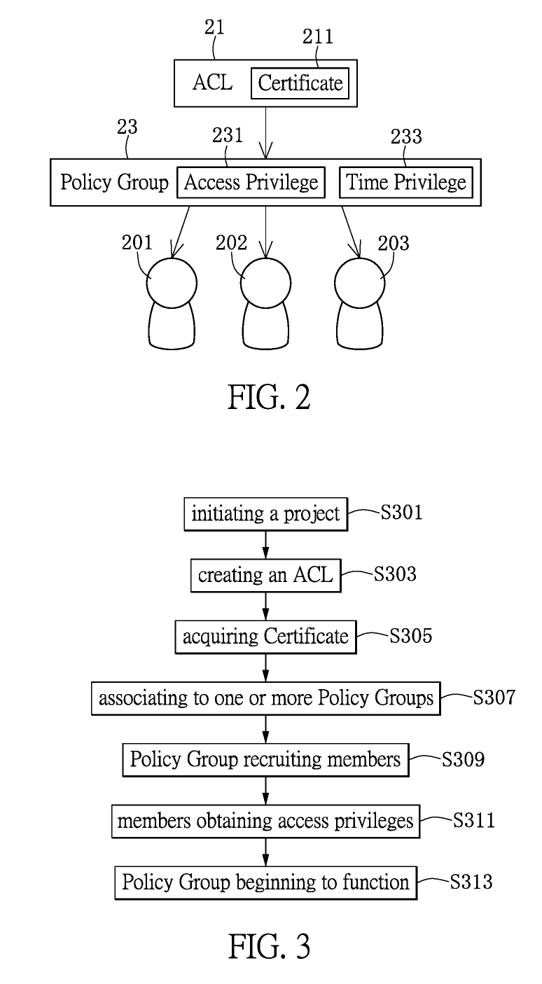

Reference is next made to FIG. 2 showing a schematic diagram describing a fundamental framework of the client-side management in one embodiment in accordance with the present disclosure. The method allows a user to create a work project and customize an ACL 21. The ACL 21 is configured to have a certificate 211 provided by the server-side management system. The certificate 211 is used to verify the identity of a user. The user ID allows the system to determine the user's subordinate policy group 23, and the information of the policy group 23 is recorded with the privilege information to the group privilege data, e.g. a group profile. In the present example, the policy group 23 directly manages the access privilege 231 with respect to several members 201, 202 and 203, and optionally includes a time privilege 233. The access privilege 231 is used to manage the privileges for the members 201, 202 and 203 to access a file. The time privilege 233 causes the members' privileges to change over time. These privileges are applicable to one or more files in a work project, and can be specifically utilized for an additional work project. The time privilege 233 can be configured for different policy groups over time. For example, when a user joins the policy group, both the access privilege 231 and the time privilege 233 will apply to the user. The time privilege 233 causes the user to access a file with a privilege that changes during different time periods. The time privilege 233 can also be applied to a specific file, so that the file's privilege may be varied over time.

FIG. 3 flow chart depicting a management method of group files according to one embodiment of the present disclosure.

In the present example, the server-side management system is configured to set up an ACL for a work project. When an administrator begins a project, such as in step S301, a file within this group is created. The project and the file(s) are then registered to the server-side management system. The system allows the administrator to establish an ACL through the aforementioned ACL management, such as in step S303. The ACL is used to initiate this work project. Next, through the access certificate management mechanism, the server-side management system generates a certificate corresponding to the ACL. The certificate is downloaded from the server-side management system when it is actively requested by the administrator/member. In an exemplary embodiment, the server-side management system delivers the certificate to a user device by a messaging method, e.g. a text message, an electronic mail, or a push notification. The client-side management driver is installed on the user device in advanced to acquire the related certificates, such as in step S305. Furthermore, when a policy group is subordinate to an ACL and one or more members in this policy group have been established, every member in this policy group obtains a certificate corresponding to the ACL. The system can exemplarily prepare a data management host that is in charge of delivering the certificate to the user device by a messaging method. According to one of the embodiments, users may actively request the related certificates from the data management host to the user device. Next, the administrator of the system can control one or more policy groups' privileges through the corresponding ACLs, and establish a relationship among the policy groups (step S307). Later on, each policy group can recruit users as its members (step S309). Every member obtains the certificate from the server-side management system and synchronously retrieves one or more group privilege data associated to the subordinate policy group according to the certificate. Each member will have one or more access privileges with respect to his belonging policy groups according to the group privilege data (step S311). Every member uses the file(s) of the work project based on the privilege of his subordinate policy group. The policy group begins to operate (step S313). It should be noted that a member can be subordinate to several different policy groups at the same time. The management driver installed on the user device will verify the users' belonging ACL and restrict the member's usage of the file(s) within his policy group. The management driver can also be used to track user activities.

When a policy group is in operation, a header is applied to the file(s) created. The information of the header exemplarily includes ACL ID lists, a file encryption key (FEK), a file rescue key, and a file user key (user FEK) with respect to the file registered in the server-side management system. Based on the ACL certificate, the member in each policy group obtains the access privilege from the data management host. When the policy group begins to operate, every member can be authorized to read, write, print, copy, delete, and convert encrypted files subordinate to the ACL according to the group privilege data.

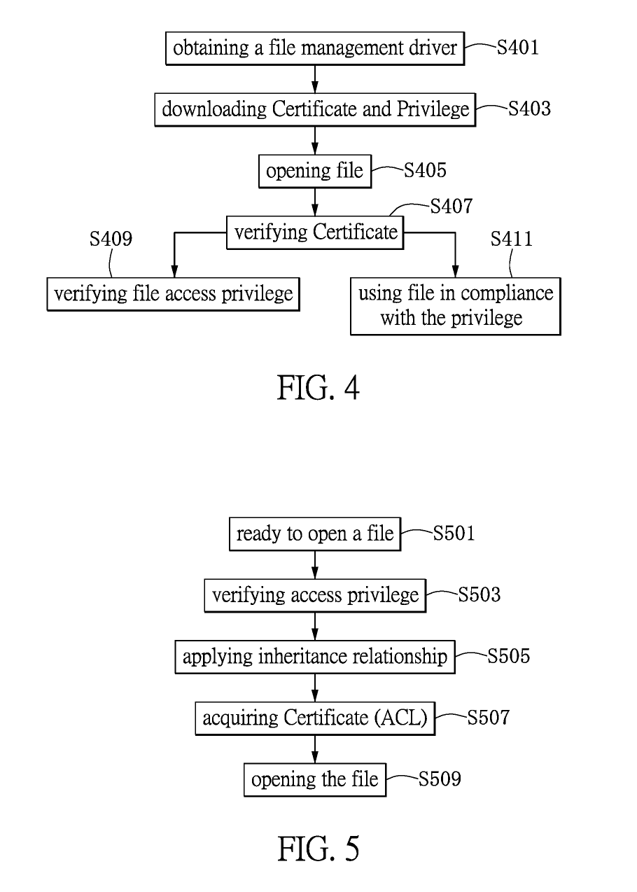

The management driver installed on the user device is used to confirm that the privilege data correctly controls the user's access privilege within his belonging ACL and policy groups. In one embodiment, reference is made to the flow chart shown in FIG. 4. In an initial stage, every member of a policy group downloads the management driver from the server-side management system (step S401). The management driver is installed to a computer system. When a file is opened, such as in step S403, the management driver verifies the user's access privilege of the targeted file (step S405). The management driver first verifies the certificate obtained by the user to confirm the user identity (step S407). Afterwards, the file is authorized to be used in compliance with the group privilege policy, such as in step S411.

According to one of the embodiments, the management driver downloads the certificate and the group privilege data from the server-side management system if the member's user device has no certificate. Further, the management driver also verifies the file access privilege (step S409). That is, when the management driver is executed and determined that the user device has related certificates and group privilege data, the system will check the file privilege data. The user can then open the file after the file privilege is confirmed (step S411).

Furthermore, in addition to the above-mentioned file management mechanism, an inheritance management mechanism is introduced to the management system. The inheritance management mechanism allows different policy groups in different ACLs to obtain a privilege to control the group files according to a hierarchical inheritance relationship, or a tree structure. For example, a member of a policy group within an ACL creates a file, and sets up an access privilege which inherits to the upper-level policy groups in the tree structure. This inheritance mechanism allows members from other policy groups that are subordinate to the same or different ACLs to acquire the access privilege of the file.

Next, FIG. 5 shows a flow chart depicting another situation when the client-side management driver responses to a request with inheritance data according to one embodiment of the present disclosure. The above-mentioned embodiment shows that the members in each policy group access a file according to their corresponding privilege. When a file is opened with the management driver executed, such as in step S501, the management driver first verifies the user ID and the access privilege which allows the user to access the file, such as in step S503. If the access privilege involves an inheritance relationship, this inheritance relationship ruled by the group privilege data is applied to the file, such as in step S505. In the meantime, the management driver asks for a corresponding certificate so that the user can open the file, such as in step S507. The user can inherit the access privilege to other groups based on the certificate. If the access privilege based on the inheritance relationship has been confirmed, the user can use the file according to the privilege, such as in step S509.

A detailed explanation of the inheritance mechanism is addressed in this paragraph. The system administrator sets up a hierarchical relationship of the policy groups in a tree structure moving upwards. The inherited policy groups can acquire additional access privileges based on the inheritance control. The members of the inherited policy groups can use the encrypted files from the lower-level policy groups within the same tree structure based on the inherited access privilege. The levels of the inheritance and the privilege to access the files are attributes controlled by the policy groups' administrators. Therefore, other than specific work projects that are not within the inheritance tree structure, every policy group can acquire an access privilege of a file through this inheritance mechanism.

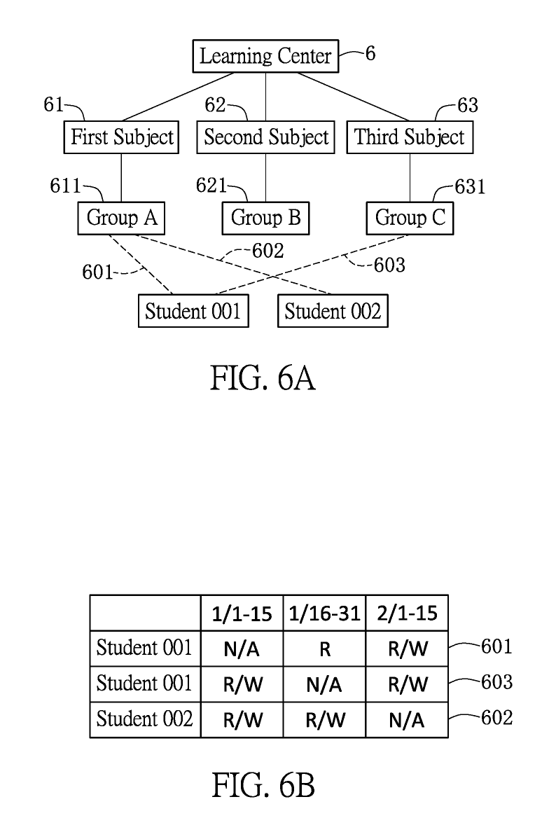

An application of the group file management method for a learning center with different subjects can be referred to the embodiment described in FIG. 6A

The figure shows an example of the server-side management system that embodies a learning center. A learning center 6 is provided. A plurality of subjects, e.g. a first subject 61, a second subject 62, and a third subject 63, can be derived from this learning center 6. Every subject acts as a work project with an ACL established to it. The ACL has related certificates for verifying the access privilege of the encrypted files. One or more policy groups subordinate to every ACL are created. For example, the first subject 61 has a group A (611) that includes students such as students 001 and 002. The students 001 and 002 acquire the certificates with respect to the access privilege of the related subjects and files. The students 001 and 002 obtain the access privilege, e.g. the right to read, write, print, copy, delete, and convert files, controlled by the group A (611) under the first subject 61. The connections 601 and 602 exemplarily show the privilege relationship.

The second subject 62 has a group B (621) policy group. Similarly, one or more students (not shown in the diagram) of the second subject 62 is subordinate to the group B (621). The students under the group B (621) acquires a certificate with respect to the second subject 62, and therefore obtain the privilege to access the files of the second subject 62. The students are accordingly able to read, write, print, copy, delete, and convert the files based on the access privilege with respect to the group B (621). The third subject 63 has a policy group C (631). The group C (631) may have several students. For example, the group C (631) associates with the student 001 over a privilege relationship 603. The student 001 can therefore acquire the privilege to access the files relating to the third subject 63. It is worth noting that the student 001 can simultaneously be subordinate to the group A (611) and the group C (631), i.e., the student 001 can access the files related to the first subject 61 and the third subject 63 at the same time. The student 001 uses the subject files based on the access privileges respectively according to the group A (611) and the group C (631).

FIG. 6B shows a table depicting time privileges of the management system for the students 001 and 002 in a learning center.

In the diagram, the subject is configured to apply a timeline for students using the time privilege mechanism. The privilege relationship 601 represents that the student 001 has different access privileges for the subject, e.g. the first subject 61, over time. For example, the diagram shows that the student 001 has no access privilege (N/A) on the subject during the time period 1/1-15; the student 001 has read privilege (R) on the subject during the time period 1/16-31; and the student 001 has both read and write (R/W) privileges during the time period 2/1-15.

Further, the student 001 has another privilege relationship 603 to the third subject 63, and the diagram shows that the privilege for accessing the subject changes over time when it is introduced with the time privilege. The student 001 also has different access privileges to access the third subject 63 over time. For example, the student 001 has both read and write privileges (R/W) to access the subject, e.g. the third object 63, during the time period 1/1-15, no privilege to access the subject during the time period 1/16-31; and regains the read and write privileges (R/W) to access the subject during the time period 2/1-15.

The privilege relationship 602 represents the student 002's access privilege of the first subject 61 varies during different time intervals. For example, the student 002 has both read and write privileges (R/W) during both the time periods 1/1-15 and 1/16-31; and no access privilege during the time period 2/1-15.

Furthermore, in view of the diagrams of FIG. 6A and FIG. 6B, the student 001 can attend the courses of both the first subject 61 and the third subject 63, but the student 002 can only attend the course of the first subject 61. Further, the student 001 cannot access the file of the first subject 61 during the time 1/1-15, and only has the privilege to read (R) on the first subject 61 during the time 1/16-31. In an exemplary example, the learning center provides a chance for the student 001 to try out the first subject 61 during the time period 1/16-31. Next, the student 001 gains a full privilege to access the subject, e.g. read and write the files related to the subject, during the time period 2/1-15.

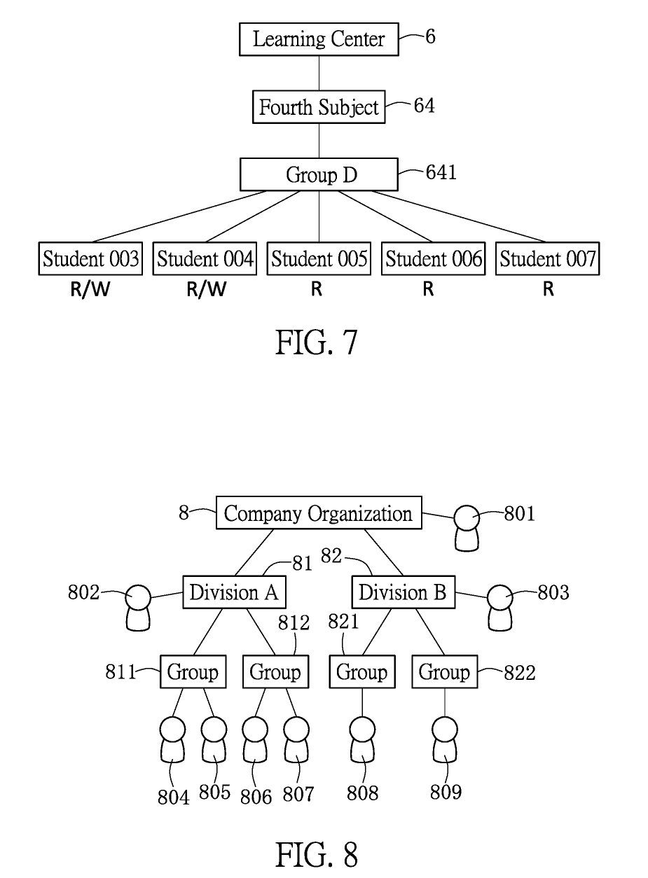

FIG. 7 shows an example for describing students' privilege status in the same subject group of a learning center.

Under the learning center 6, a fourth subject 64 is provided. The fourth subject 64 is configured to have a policy group D (641). A plurality of students 003˜007 can join the policy group D (641) for accessing the course files of the fourth subject 64. According to a group privilege data with respect to the policy group D (641), the students 003, 004, 005, 006 and 007 have different access privileges to the course files of the fourth subject 64. For example, the student 003 owns both read and write access privileges (R/W) to the course files of the fourth subject 64, and the student 004 also owns the read and write privileges (R/W) to the course files of the fourth subject 64. The student 005, the student 006 and student 007 can only read the files of the fourth subject 64.

Specifically, the example shows that the student 003 and the student 004 are the formal students under the fourth subject 64, and therefore can obtain the full access privilege to the whole course. On the other hand, the student 005, the student 006 and the student 007 are only trying out the course related to the fourth subject 64. The students 005˜007 obtain limited privilege, e.g. read privilege, to the course.

The management system can be applied to a company for managing the organizational structure thereof, including the various divisions under this organization. The various divisions of the company form the policy groups under the management system. Each policy group includes one creator, one or more members, and one or more administrators. The administrator is such as a chief executive officer (CEO), a division manager, or a group leader of the company. An administrator of a policy group can organize the group structure and its members' access privileges. An administrator can also invite users from other ACL or work project to join a specific work project.

In an exemplary example, this group file management system may act as a data management center of a company. Each policy group represents a division or a special project group. The members of the policy group become the members of the division or the members recruited for the project. Each member may be subordinate to one or more policy groups at the same time. Each policy group has a group privilege data that is used to record the members' access privileges to the files created by the policy group. The group privilege data restricts the members' privileges to read, write, print, copy, delete, and convert the files.

Reference is made to FIG. 8, which shows a schematic diagram describing a hierarchical relationship in a company applying the management method of group files in one embodiment of the present disclosure. The management hierarchy includes a plurality of policy groups being subordinate to one ACL for the whole company. The policy groups include a company organization 8, a division A (81), a division B (82), and groups 811, 812, 821 and 822. The members within the policy groups own the privileges to access the files generated under the ACL. The members can acquire group privilege data with respect to their policy groups. The members can have different privileges from one another, and their privilege information is saved to the corresponding group privilege data. The file header recording information such as ACL ID lists and the related FEK is registered in the server-side management system. The server-side management system verifies the members in the policy groups based on the certificate of the ACL. While the policy group begins to operate, each member may have the rights to read, write, print, copy, delete, and convert the files subordinate to the ACL according to the group privilege data.

The highest level of the company is such as the company organization 8 that appoints a CEO 801. The lower level of the company organization 8 includes a division A (81) and a manager 802 who leads this division A (81); and a division B (82) which also has a manager 803. The division A (81) further includes a group 811 and a group 812. The division B (82) includes a group 821 and a group 822. The company organization 8, the divisions, and the groups are each operated as an individual policy group.

In the present example, the group 811 has members 804 and 805; the group 812 has members 806 and 807; the group 821 has a member 808; and the group 822 has a member 809. The members in each policy group have access to the group files in compliance with the privilege recorded in the group privilege data.

With the hierarchical structure, e.g. a group tree, in present, the company organization 8 can utilize the inheritance management mechanism in the management system. The inheritance management mechanism allows the groups 811, 812, 821, and 822 to inherit their access privileges to the higher-level divisions A and B, and finally reaches the highest level where the CEO 801 and the company organization 8 located. This inheritance mechanism allows members from higher policy groups to acquire the access privilege to the files generated in the lower level policy groups of the hierarchical structure.

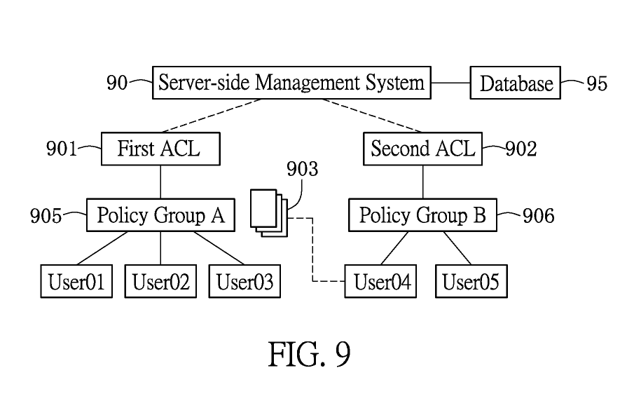

In addition to using the policy group and the hierarchical structure mechanism to regulate the user privileges under the management system, the members who are subordinate to different policy groups may also obtain the privileges to access the files generated from different ACLs by acquiring the corresponding certificates and the related privilege data. FIG. 9 further shows a method of sharing files between different groups and ACLs in the management system in one embodiment of the present disclosure.

The embodiment shown in FIG. 9 depicts a circumstance when a member not only acquire the privileges to access the files generated under his belonging policy groups of the same ACL, but also have access to the files created by other policy groups under different ACLs.

A server-side management system 90 shown in the diagram exemplarily includes a database 95, and two ACLs: the first ACL 901 and the second ACL 902, are created under the management system 90. The policy group A (905) is subordinate to the first ACL 901, and the policy group B (906) is subordinate to the second ACL 902. The policy groups (905, 906) respectively recruit their own members, for example the users 01, 02 and 03 are subordinate to the policy group A (905), and the users 04 and 05 are in the policy group B (906).

Through the system in accordance with the present disclosure, the members in each policy group can acquire the access privilege, e.g. the rights to read, write, print, copy, delete, and convert the files, associated to the corresponding policy groups. The members can also obtain the privilege to access the files generated across different ACLs. The management system allows a user to share the privilege of a specific file to other users across different ACLs by converting the file header or applying to join the file's belonging ACL. When a member or an administrator of the policy group A (905) acquires the access privilege to convert the file 903's file header, he can then share the file 903 to the user 04 by simply converting the file header from the first ACL 901 to the second ACL 902. On the other hand, if the user 04 wishes to access the file 903 which he does not have the privilege to, he can apply to join the policy group A 905 through the review process of the management system.

For example, when the user 04 of the policy group B (906), which is subordinate to the second ACL 902, wishes to access the file 903 generated under the policy group A (905), which is subordinate to the first ACL 901, the user 04 needs to send a request to the administrator of the first ACL 901 to gain the access privilege of the file 903. There might be a circumstance in a company organization where the user 04 needs to notify the administrator of the second ACL 902 before he applies to join the first ACL 901, but we will mainly focus on the general usage right now. First, the system may provide an application page for the user 04 to fill out. Then, the system administrator or any policy group administrator of the first ACL 901 can examine this application. The user 04 can successfully join the policy group A (905) that is subordinate to the first ACL 901 after the administrator reviews and approves the application. Then the user 04 can reach the file 903 with the access privilege that the administrator grants him

When the user 04 opens the file 903, the user 04 may first link to the server-side management system 90, and acquires a certificate with respect to the first ACL 901, a group privilege data, and a file privilege data, e.g. a file profile, corresponding to the file 903. In the meantime, the user 04 can actively request for the certificate and the privilege data from the system 90. Then the user 04 can utilize the management driver installed in his user device to open the file 903 when the certificate is verified and the user 04 is confirmed to have the group privilege. The usage of the file 903 is also in compliance with its file privilege.

According to one aspect of the present disclosure, in a specific project, the members' privileges of the project may not be restricted to their original company, division or organization. They may obtain the access privilege of the files created by other companies, divisions or organizations.

In accordance with the present disclosure, the management system can efficiently manage the access privileges of the group files in the company divisions through the policy group mechanism. Further, while a work project is configured, the system allows one or more administrators to flexibly deploy policy groups associated to this project in advanced. A tree-like organizational structure is therefore established, which allows the members from different divisions or companies to join this project. The aforementioned inheritance mechanism can be utilized here for various policy groups.

When the project initiates, the server-side management system is incorporated to create an ACL and generate project files. The ACL associates to one or more policy groups and grants the members certificates to open the files. With respect to the belonging policy groups, every member can have different access privileges, including to read, write, print, copy, delete, and convert the encrypted files. The advantage of the management system is that, any alternation of the policy groups within the ACL will not affect the files to be shared among other users. For example, the header of the file will not be altered to be shared among the users in different policy groups even when the policy groups have been modified.

Furthermore, an aspect of groups' time privilege controls in a project life cycle applying the management method is introduced in one embodiment of the present disclosure

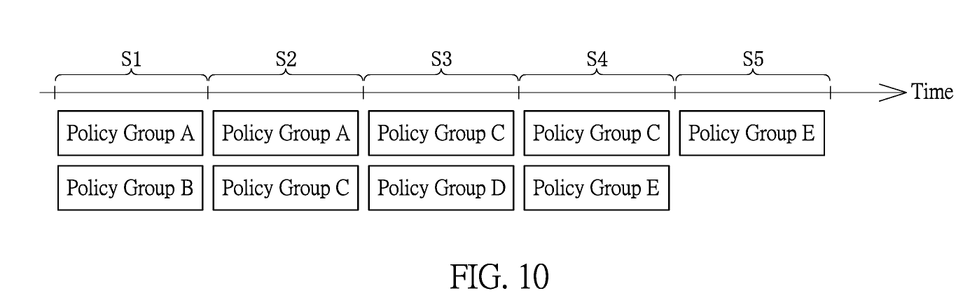

Reference is made to FIG. 10, showing a privilege timeline divided into several stages for a work project. In the management system, the policy groups' access privileges for the project files can be altered over time. The file header records the ACL ID lists that determine the access privilege of the members, and can control the time privilege and the number of access of the file. The time privilege allows the members to have different access privileges to the files at different time periods, and can further regulates the number of access of the files when it is fully utilized. This aspect of the time privilege allows the members to go beyond the limitations of policy groups, which means different policy groups and members can collaborate on a single work project sharing the same files with their access privileges predetermined or set up for the project life cycle.

For example, in FIG. 10, at the first time stage S1, the access privilege of the project files is released to the members in both the policy group A and the policy group B. It should be noted that the members can still have different access privileges, e.g. to read, write, print, copy, delete, and convert the file under the time privilege controls.

Later, at the second time stage S2, the policy groups with the access privileges change to the policy group A and the policy group C. At a third time stage S3, the policy group C continuously to own the privilege to access the files and the policy group D is joined. At the fourth time stage S4, the system allows the policy group C and the policy group E to have the privileges to access the files. At the last time stage S5, only the policy group E owns the privilege.

Furthermore, the management system is applicable to a Product Life Management (PLM) system according to one embodiment of the present disclosure. PLM acts as an information management center, which is used to integrate business information and process, marketing and human resources of an extending enterprise. A PLM software can help a user in creating ideas, designing, and manufacturing a product, and even in maintenance and follow-up service. A PLM can manage the business information with high efficiency and in a cost-effective manner during a whole product lifecycle.

For example, in a company development project, several policy groups responsible for research and development at different time stages can be involved in this project. The policy groups can be formed with respect to the members' duties, such as creating ideas, designing, manufacturing, and maintaining after-sales services of a product. One of the policy groups can be responsible for an initial development. Another policy group can be in charge of the next stage of R&D. The members of the initial policy group can still join another policy group to push the development forward. After that, when the project has reached to a later stage, other policy groups take over to complete the process. In the whole process of R&D, the management system can control the members' privileges to access the sensitive data of the project at different time stages. In one embodiment, some members, such as the R&D manager, can be subordinate to multiple policy groups to overlook the progress of the project. If there is a hieratical structure embedded for the company in the management system, the R&D manager can join a higher level policy group, such as a manager team, which directly inherits the access privileges of the lower policy group, such as a developer team. Further, the system also allows each member to have different time privileges during the process of R&D, and each individual member can have different privileges, e.g. to read, write, print, copy, delete, and convert the files at different time stages.

Through the above mentioned embodiments of the management system and method, a secured file management mechanism is provided by the operations of the ACL certificate and the policy groups. The system also provides a flexible solution to manage the group files by adapting ACL-based policy groups to manage the access privilege of the files. Any changes in policy groups and members will not affect the file header, thereby achieving an efficient way to manage group files.

It is intended that the specifications and the depicted embodiments be considered exemplary only, with a true scope of the invention being determined by the broad meaning of the following claims.

What is claimed is:

1. A management system for group files, comprising:
one or more processors; and
a memory coupled to the one or more processors and storing program instructions that when executed by the one or more processors cause the management system to:
manage an access control list through the management system for the files generated under a work project;
manage a certificate provided by the management system for a user to download the certificate of each access control list;
manage a group privilege data relating to a user's access privilege of a file generated under a policy group of an access control list;
manage a file privilege data relating to an access privilege of a file;
wherein, the management system allows the user to download and install the management driver, which is used to obtain the certificate, the group privilege data associated with the policy group, and/or the file privilege data from the management system.

2. The system as recited in claim 1, wherein, an inheritance management mechanism is introduced between the policy groups, and the inheritance management mechanism creates a hieratical structure which allows different policy groups in different access control lists to obtain a privilege to control the group files.

3. The system as recited in claim 1, wherein, each work project with respect to its access control list creates a file with a header including ACL ID lists, the creator's token, the time privilege, and the number of access.

4. The system as recited in claim 3, wherein, an inheritance management mechanism is introduced between the policy groups, and the inheritance management mechanism creates a hieratical structure which allows different policy groups in different access control lists to obtain a privilege to control the group files.

5. The system as recited in claim 1, wherein, the policy group management module is used to manage one of more members' access privileges, including a time privilege, of a file generated in each policy group; the time privilege causes the members' privilege to access the file to change over time while the file privilege management module controls the access and time privilege of a specific file.

6. The system as recited in claim 5, wherein, an inheritance management mechanism is introduced between the policy groups, and the inheritance management mechanism creates a hieratical structure which allows different policy groups in different access control lists to obtain a privilege to control the group files.

7. A method for managing group files, comprising:
selecting a default access control list or creating an access control list with respect to a work project;
acquiring a certificate corresponding to the access control list from a server-side management system;
establishing one or more policy groups associated to the access control list, wherein each policy group has one or more members;
wherein the member is subordinate to one or more policy groups, every member obtaining the certificate from the server-side management system and synchronously retrieving one or more group privilege data associated to the subordinate policy groups according to the certificate; and every member obtaining one or more access privileges of the files with respect to one or more policy groups according to the group privilege data; and
each policy group beginning to operate, every member is allowing to read, write, print, copy, delete, and convert a file subordinate to the access control list according to the group privilege data.

8. The method as recited in claim 7, wherein the privilege associated to a file is manageable and can be shared across different access control lists associated to difference work projects.

9. The method as recited in claim 7, wherein the certificate is acquired by the member actively from the server-side management system, and the server-side management system delivers the certificate to a user device by a messaging method.

10. The method as recited in claim 9, wherein the privilege associated to a file is manageable and can be shared across different access control lists associated to difference work projects.

11. The method as recited in claim 9, wherein, steps for the member accessing the file associated to the subordinate policy group comprise:
opening the file after the management driver is executed;
the management driver identifying the member, verifying an access privilege to the file, and verifying the certificate acquired by the member;
the management driver downloading the certificate and the group privilege data from the server-side management system if the member's user device has no certificate; and the management driver verifying the member's access privilege to the file according to the group privilege data;
allowing the member to open the file after the member's access privilege has been confirmed if the member's user device has the related certificates and group privilege data; and
according to the file access privilege, accessing the file.

12. The method as recited in claim 11, wherein the privilege associated to a file is manageable and can be shared across different access control lists associated to difference work projects.

13. The system as recited in claim 11, wherein, the policy group management module is used to manage one of more members' access privileges, including a time privilege, of a file generated in each policy group; the time privilege causes the members' privilege to access the file to change over time while the file privilege management module controls the access and time privilege of a specific file.

14. The system as recited in claim 7, wherein, in the server-side management system, each work project with respect to its access control list creates a file with a header including ACL ID lists, the creator's token, the time privilege, the number of access, a security-related file encryption key, a file rescue key, and a file user key while the group privilege data records the access privilege of every member within a policy group, including the privilege to read, write, print, copy, delete, and convert a file subordinate to the access control list.

15. The method as recited in claim 14, wherein the privilege associated to a file is manageable and can be shared across different access control lists associated to difference work projects.
